(19) United States
(12) Patent Application Publication
(10) Pub. No.: US 2010/0289792 A1
(43) Pub. Date: Nov. 18, 2010

(54) METHOD FOR DRIVING A TRI-GATE TFT LCD

(76) Inventors: Yuan-Yi Liao, Taipei County (TW); Chao-Hui Hsu, Taoyuan County (TW); Liang-Ming Yu, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/534,152

(22) Filed: Aug. 2, 2009

(30) Foreign Application Priority Data
May 13, 2009 (TW) 098115818

(51) Int. Cl. G06F 3/038

(52) U.S. Cl. 345/213; 345/94

(57) ABSTRACT

A method for driving a tri-gate TFT-LCD includes providing a polarity converting common voltage. When polarity of the common voltage is converted, a first gate line is turned on for a source line to charge a first sub-pixel for a first write in duration. When the first gate line is turned off, a second gate line is turned on for the source line to charge a second sub-pixel for a second write in duration. When the second gate line is turned off, a third gate line is turned on for the source line to charge a third sub-pixel for the second write in duration. By adjusting the first write in duration the first sub-pixel can be fully charged, consequently improving the color deviation of the displayed image.

### BACKGROUND OF THE INVENTION

1. Field of the Invention

The present invention is related to a driving method of a Thin Film Transistor Liquid Crystal Display (TFT-LCD) device, and more particularly, to a driving method of a TFT-LCD device having a tri-gate pixel structure.

2. Description of the Prior Art

The pixel structure of the TFT-LCD device, according to different driving modes, may generally be categorized into two types; single-gate pixel structure and tri-gate pixel structure.

Please refer to FIG. 1. FIG. 1 is a diagram illustrating a conventional TFT-LCD device 10 having a tri-gate pixel structure. Taking a resolution of n*m as an example, the TFT-LCD device 10 having the tri-gate pixel structure comprises m*3 gate lines G₁˜G₃ₘ, and n data lines D₁˜Dₙ. As shown in FIG. 1, the gate lines G₁˜G₃ₘ and the data lines D₁˜Dₙ together defines 3*m*n sub-pixels. The sub-pixels are red sub-pixels R, green sub-pixels G and blue sub-pixels B. The gate lines G₁˜G₃ₘ are electrically connected to the gate driver module 12 and the data lines D₁˜Dₙ are electrically connected to the source driver module 14. When displaying images with the resolution of n*m pixels, the TFT-LCD device 10 having the tri-gate pixel structure comprises includes 3*m gate lines and n data lines, whereas the TFT-LCD device having a single-gate pixel structure comprises m gate lines and 3*n data lines. In other words, under identical resolution, the number of gate lines of the TFT-LCD device 10 having the tri-gate pixel structure is triple to that of the TFT-LCD device having the single-gate pixel structure; however the number of scan lines of the TFT-LCD device 10 having the tri-gate pixel structure is only ⅓ of that of the TFT-LCD device having the single-gate pixel structure. Therefore the conventional TFT-LCD device 10 having the tri-gate pixel structure, compare to the single-gate pixel structure, employs more gate drivers but less source drivers. Since the cost and power consumption of the gate driver is less than that of the source driver, utilizing the TFT-LCD device having the tri-gate pixel structure is more advantageous due to the relatively low cost and low power consumption.

Please refer to FIG. 2. FIG. 2 is a timing diagram illustrating the driving voltages of the conventional TFT-LCD device 10 having the tri-gate pixel structure. The gate lines G₁˜G₃ corresponds to the red sub-pixel R, the green sub-pixel G and the blue sub-pixel B of a first pixel P₁ respectively. As shown in FIG. 2, as the common voltage VCOM converts polarity from a low voltage level to a high voltage level, the display data of the source line S reach a predetermined voltage level V_{R1} after a setup duration t_{P}. The TFT-LCD device 10 turns on the gate line G₁ of the first pixel P₁ at time t_{G1} for transmitting the display data of the source line S to the red sub-pixel R of the first pixel P₁ (i.e. equivalent to charging the red sub-pixel R). When the source line S charges the red sub-pixel R for a write in duration t_{R1}, the TFT-LCD device 10 turns off the gate line G₁. When the gate line G₁ is turned off for a wait duration t_{W}, the TFT-LCD device 10 turns on the gate line G₂ of the first pixel P₁ at the time t_{G2}, for transmitting the display data of the source line S to the green sub-pixel G of the first pixel P₁ (i.e. equivalent to charging the green sub-pixel G). When the source line S charges the green sub-pixel G for a write in duration t_{R2}, the TFT-LCD device 10 turns off the gate line G₂. When the gate line G₂ is turned off for a wait duration t_{W}, the TFT-LCD device 10 turns on the gate line G₃ of the first pixel P₁, for transmitting the display data of the source line S to the blue sub-pixel B of the first pixel P₁ (i.e. equivalent to charging the blue sub-pixel B). When the source line S charges the blue sub-pixel B for a write in duration t_{R3}, the TFT-LCD device 10 turns off the gate line G₃. When the gate line G₃ is turned off for a wait duration t_{W}, the source line S terminates transmitting the display data. After the source line S terminates transmitting the display data, the common voltage V_{COM} converts polarity from the high voltage level to the low voltage level. The period between each time the common voltage V_{COM} converts polarity is the duration t_{VCOM}. As the common voltage V_{COM} converts polarity, the display data of the source line S reach a predetermined voltage level after a setup duration t_{P}, and the gate lines G₁˜G₃ of a second pixel are sequentially turned on and turned off similar to that of the first pixel P₁. In other words, every time the TFT-LCD device 10 has sequentially turned on and turned off the gate lines G₁˜G₃, the common voltage V_{COM} converts polarity. After the common voltage V_{COM} converts polarity, the display data of the source line S reach a predetermined voltage level after a setup duration t_{P}, and the TFT-LCD device 10 turns on and turns off the gate lines G₁˜G₃ of the next pixel sequentially, similar to the operation process of the first pixel P₁ described.

However, when the TFT-LCD device 10 displays the frame of a middle tone, the red sub-pixel R may be charged insufficiently, resulting in inaccurate color display. Please refer to FIG. 3. FIG. 3 is a timing diagram illustrating the red sub-pixel R of the conventional TFT-LCD device 10 having the tri-gate pixel structure being insufficiently charged. As shown in FIG. 3, the red sub-pixel R is the first pixel the source line S charges and the display data of the source line S is unable to reach the predetermined voltage level V_{R1} instantly. Therefore the red sub-pixel R is turned off before the display data of the source line S reach the predetermined voltage level V_{R1}, causing the red sub-pixel R to be insufficiently charged. When the red sub-pixel R is insufficiently charged, the display of the red sub-pixel R deviates to a higher brightness. In contrast, since the display data of the source line S have reached the predetermined voltage level V_{R1} when the green sub-pixel G and the blue sub-pixel B are turned on, the green sub-pixel G and the blue sub-pixel B are both fully charged for displaying accurate color representation. Therefore, when the TFT-LCD device 10 displays the frame of a middle tone, the color of the frame is deviated towards red, causing inaccurate visual effect.

### SUMMARY OF THE INVENTION

The present invention provides a method for driving a tri-gate Thin Film Transistor Liquid Crystal Display (TFT-LCD) device. The TFT-LCD device comprises a plurality of pixels where each pixel of the plurality of pixels comprises a first sub-pixel electrically connected to a first gate line and a source line, a second sub-pixel electrically connected to a second gate line and the source line, and a third sub-pixel electrically connected to a third gate line and the source line. The method comprises: providing a polarity converting common voltage; when polarity of the common voltage is converted, a first gate line is turned on after a setup duration, and the source line transmits a display data to charge the first sub-pixel for a first write in duration; when the first gate line is turned off for a wait duration, the second gate line is turned on and the source line transmits the display data to charge the second sub-pixel for a second write in duration; and when the second gate line is turned off for the wait duration, the third gate line is turned on and the source line transmits the display data to charge the third sub-pixel for the second write in duration.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a conventional TFT-LCD device having a tri-gate pixel structure.

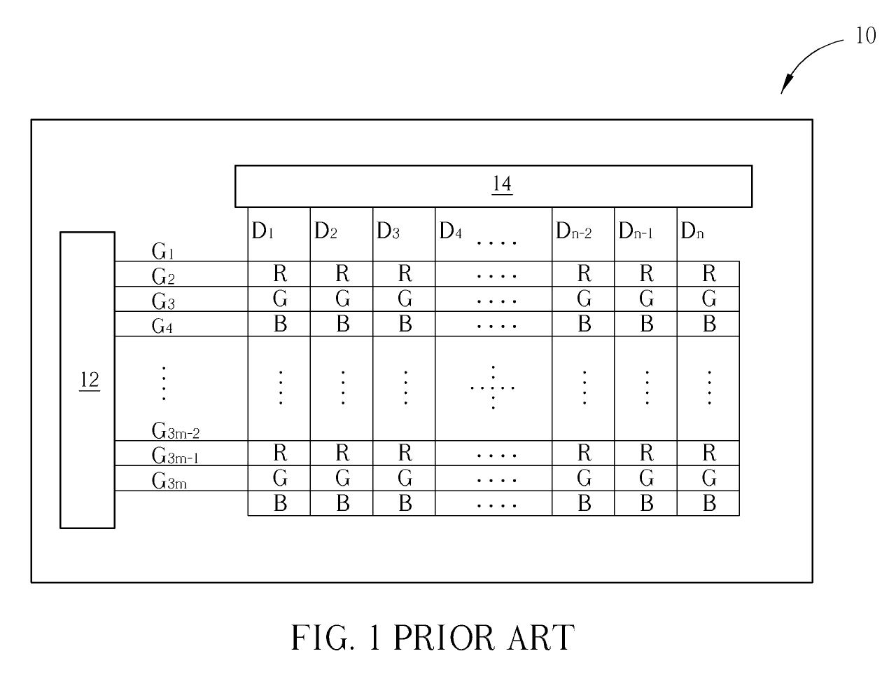

FIG. 2 is a timing diagram illustrating the driving voltages of the conventional TFT-LCD device having the tri-gate pixel structure.

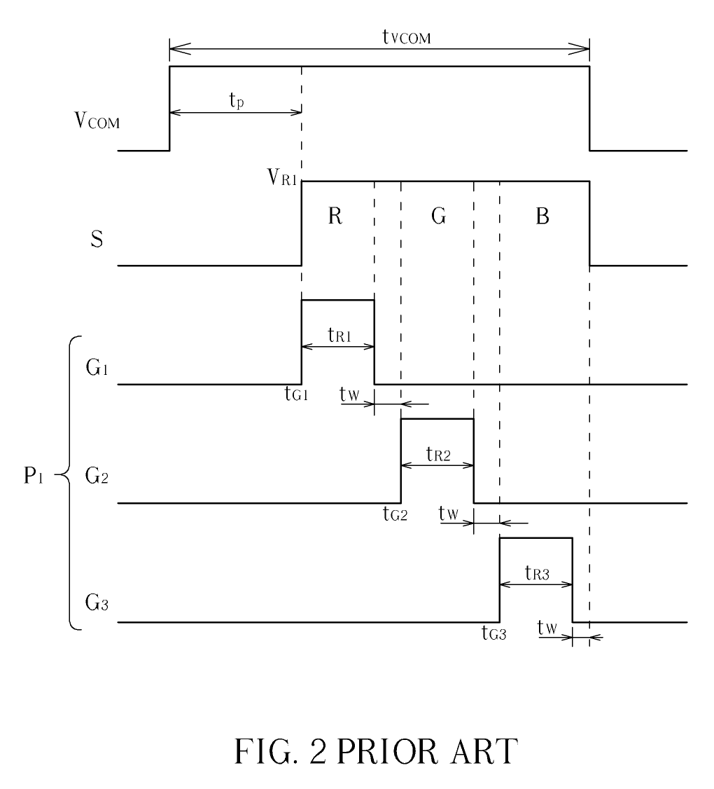

FIG. 3 is a timing diagram illustrating the red sub-pixel R of the conventional TFT-LCD device having the tri-gate pixel structure being insufficiently charged.

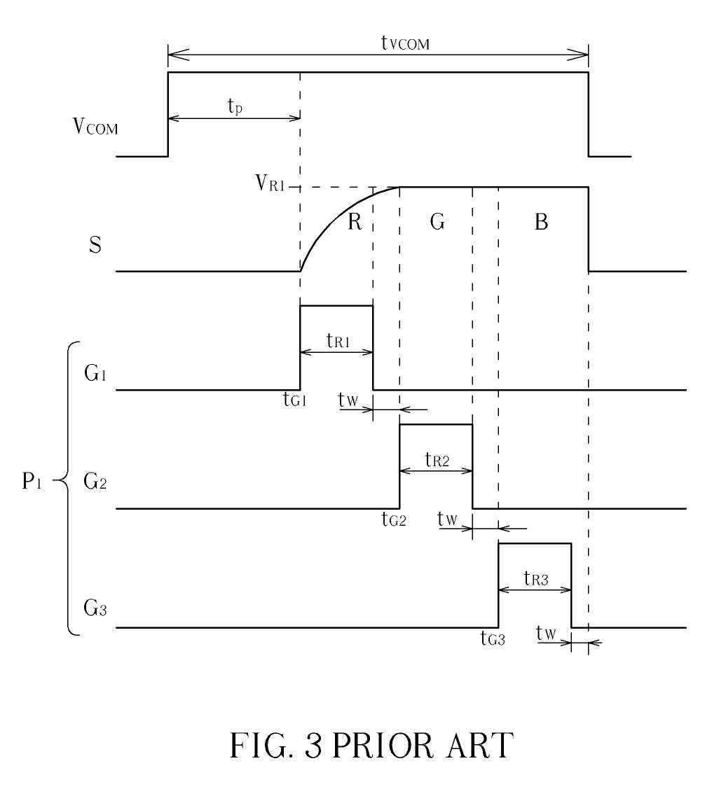

FIG. 4 is a timing diagram illustrating the TFT-LCD device having a tri-gate pixel structure of the present invention.

FIG. 5 is a timing diagram illustrating the driving method of the TFT-LCD device having a tri-gate pixel structure according to an embodiment of the present invention.

### DETAILED DESCRIPTION

Certain terms are used throughout the description and following claims to refer to particular components. As one skilled in the art will appreciate, electronic equipment manufacturers may refer to a component by different names. This documents does not intend to distinguish between components that differ in name but not function. In the following description and in the claims, the terms “include” and “comprise” are used in an open-ended fashion, and thus should be interpreted to mean “include, but not limited to . . . . ” Also, the term “electrically connect” is intended to mean either an indirect or direct electrical connection. Accordingly, if one device is coupled to another device, that connection may be through a direct electrical connection, or through an indirect electrical connection via other devices and connections.

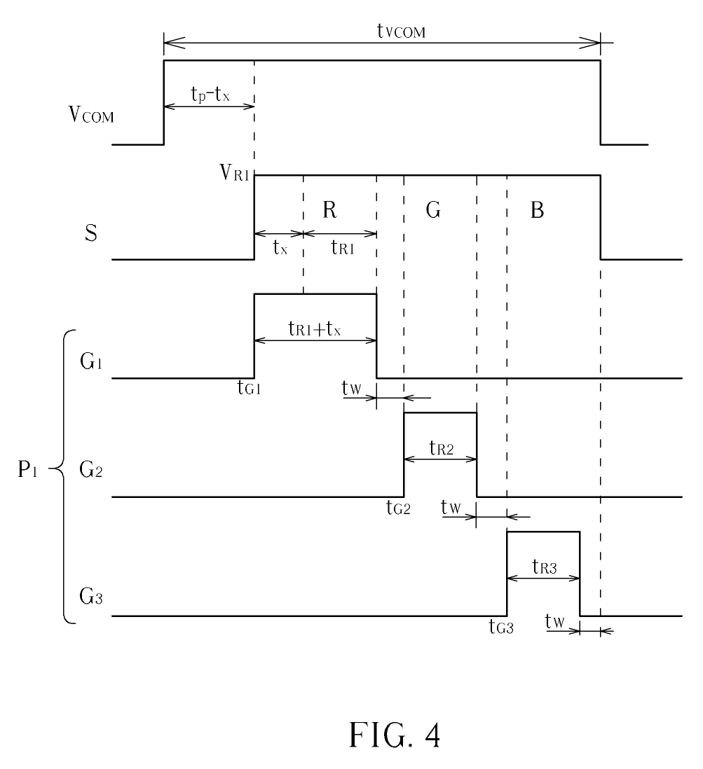

Please refer to FIG. 4. FIG. 4 is a timing diagram illustrating the Thin Film Transistor Liquid Crystal Display (TFT-LCD) device having a tri-gate pixel structure of the present invention. As shown in FIG. 4, as the common voltage V_{COM} converts polarity from a low voltage level to a high voltage level, the display data of the source line S reach a predetermined voltage level V_{R1} after a setup duration t_{P}. The TFT-LCD device turns on the gate line G₁ of the first pixel P₁ at time t_{G1}, for transmitting the display data of the source line S to the red sub-pixel R of the pixel P₁. When the source line S charges the red sub-pixel R for a write in duration t_{R1}, the TFT-LCD device turns off the gate line G₁. When the gate line G₁ is turned off for a wait duration t_{W}, the TFT-LCD device turns on the gate line G₂ of the first pixel P₁, for transmitting the display data of the source line S to the green sub-pixel G of the first pixel P₁. When the source line S charges the green sub-pixel G for a write in duration t_{R2}, the TFT-LCD device turns off the gate line G₂. When gate line G₂ is turned off for a wait duration t_{W}, the TFT-LCD device turned on the gate line G₃ of the first pixel P₁ for transmitting the display data of the source line S to the blue sub-pixel B of the first pixel P₁. When the source line S charges the blue sub-pixel B for a write in duration t_{R3}, the TFT-LCD device turns off the gate line G₃. When the gate line G₃ is turned off for the wait duration t_{W}, the source line S stops transmitting the display data. After the source line S stops transmitting the display data, the common voltage V_{COM} converts polarity from the high voltage level to the low voltage level.

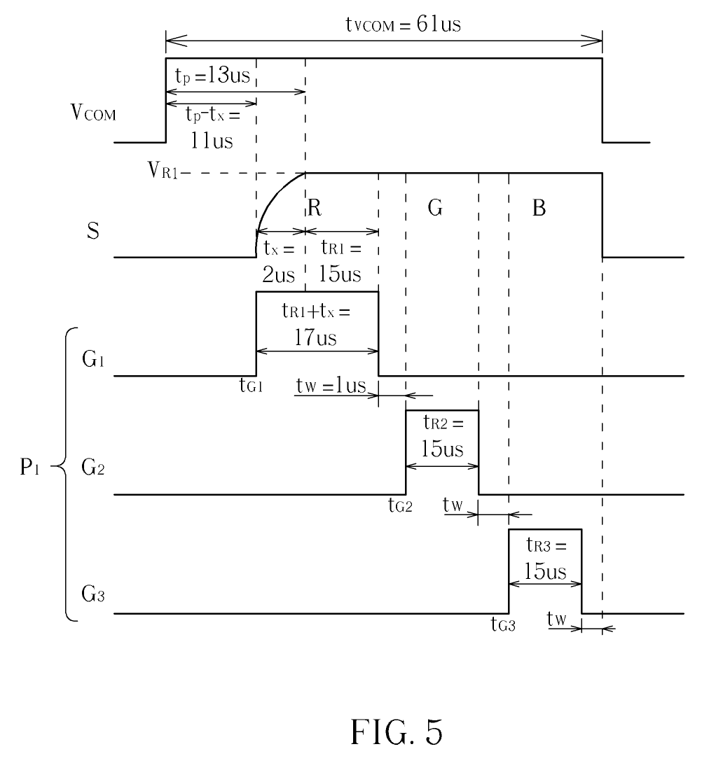

Since the red sub-pixel R is the first sub-pixel that the source line S charges, and the display data of the source line S is unable to reach the predetermined voltage level V_{R1} instantly, so the red sub-pixel R is turned off before the display data of the source line S reach the predetermined voltage level V_{R1}, consequently causing the red sub-pixel R to be insufficiently charged. Therefore, in the present invention, the time t_{G1} at which the gate line G₁ is turned on and the write in duration t_{R1} (i.e. the duration of which the gate line G₁ is charged) are adjustable, and the length of adjusted time duration is represented by t_{X}. For instances, the time t_{G1} is adjusted so that the gate line G₁ is turned on earlier for the duration t_{X}, and the write in duration t_{R1} is adjusted to be (t_{R1}+t_{X}). The adjusted write in duration (t_{R1}+t_{X}) of the red sub-pixel R is longer than the write in duration t_{R2} and t_{R3} of the green sub-pixel G and the blue sub-pixel B respectively. Therefore, by increasing the write in duration of the red sub-pixel R (i.e. adjusting the time t_{G1} to an earlier time) allows the red sub-pixel R to have more time for charging and the red sub-pixel R is ensured to be in the charging state when the display data of the source line S reach the predetermined voltage level V_{R1}. It should be noted that by increasing the write in duration of the red sub-pixel R (i.e. adjusting the time t_{G1} to an earlier time) decreases the setup duration t_{P}; in other words, by decreasing the write in duration of the red sub-pixel R (i.e. adjusting the time t_{G1} to a later time) increases the setup duration t_{P}. For instances, adjusting the time t_{G1} earlier by the duration t_{X} is equivalent to adjusting the write in duration t_{R1} to (t_{R1}+t_{X}), and the setup duration t_{P} is adjusted to (t_{P}−t_{X}) accordingly. Furthermore, as illustrated in FIG. 5, to prevent affecting the polarity conversion of the common voltage V_{COM}, the sum of the adjusted setup duration (t_{P}−t_{X}), the adjusted write in duration (t_{R1}+t_{X}) of the red sub-pixel R, the write in duration t_{R2} of the green sub-pixel G, the write in duration t_{R3} of the blue sub-pixel B and three wait durations (i.e. the three wait durations are between turning off the first gate line G₁ and turning on the second gate line G₂, between turning off the second gate line G₂ and turning on the third gate line G₃, and between turning off the third gate line G₃ and turning off the source line S) 3*t_{W} must be shorter than the duration t_{VCOM}, which is the period between each time the common voltage V_{COM} converts polarity.

Please refer to FIG. 5. FIG. 5 is a timing diagram illustrating the driving method of the TFT-LCD device having a tri-gate pixel structure according to an embodiment of the present invention. As shown in FIG. 5, when the common voltage V_{COM} converts polarity, the display data of the source line S reach a predetermined voltage level V_{R1} after a setup duration t_{P}. The TFT-LCD device turns on the first gate line G₁ of the first pixel P₁ at time t_{G1}. Since the display data of the source line S is unable to reach the predetermined voltage level V_{R1} in instantly, the TFT-LCD device of the present invention adjusts the time t_{G1} to be earlier by the duration t_{X}, for reducing the setup duration t_{P} to (t_{P}−t_{X}) and increasing the write in duration of the red sub-pixel R to (t_{R1}+t_{X}). Therefore, the red sub-pixel R is not turned off before the display data of the source line S reach the predetermined voltage level V_{R1}. In other words, increasing the write in duration of the red sub-pixel R allows the red sub-pixel R to be sufficiently charged when the display data of the source line S reach the predetermined voltage level V_{R1}. Subsequently, the gate line G₁ is turned off after a write in duration (t_{R1}+t_{X}) When the gate line G₁ is turned off, the TFT-LCD device turns on the second gate line G₂ (i.e. the green sub-pixel G begins charging) at the time t_{G2}. When the source line S charges the green sub-pixel G for a write in duration t_{R2}, the TFT-LCD device turns off the second gate line G₂. When the second gate line G₂ is turned off, the TFT-LCD device turns on the third gate line G₃ (i.e. the blue sub-pixel B begins charging) at time t_{G3}. When the source line S charges the blue sub-pixel B for a write in duration t_{R3}, the TFT-LCD device turns off the third gate line G₃. More specifically, according to FIG. 5, the duration t_{VCOM}, which is the period between each time the common voltage V_{COM} converts polarity, is 61 us, the write in duration t_{R1}, t_{R2}, and t_{R3} of the corresponding gate lines G₁, G₂, and G₃ are all 15 us, the wait duration is 1 us, and the setup duration t_{P} is 13 us. If the write in duration t_{R1} of the first gate line G₁ in increased to 17 us, the setup duration t_{P} is accordingly reduced to 11 us. Therefore, the driving method of the TFT-LCD device having a tri-gate pixel structure allows the red sub-pixel R, the green sub-pixel G and the blue sub-pixel B to be fully charged and accurate color representation can be displayed respectively.

In conclusion, the present invention provides the driving method for a TFT-LCD device having a tri-gate pixel structure. The driving method comprises providing a polarity converting common voltage. When polarity of the common voltage is converted, a first gate line is turned on for a source line to charge a first sub-pixel for a first write in duration. When the first gate line is turned off, a second gate line is turned on for the source line to charge a second sub-pixel for a second write in duration. When the second gate line is turned off, a third gate line is turned on for the source line to charge a third sub-pixel for the second write in duration. By adjusting the first write in duration the first sub-pixel can be fully charged, consequently improving the color deviation of the displayed image.

Those skilled in the art will readily observe that numerous modifications and alterations of the device and method may be made while retaining the teachings of the invention.

What is claimed is:

1. A method for driving a tri-gate Thin Film Transistor Liquid Crystal Display (TFT-LCD) device, the TFT-LCD device comprising a plurality of pixels where each of the plurality of pixels comprises a first sub-pixel electrically connected to a first gate line and a source line, a second sub-pixel electrically connected to a second gate line and the source line, and a third sub-pixel electrically connected to a third gate line and the source line, the method comprising:
providing a polarity converting common voltage;
when polarity of the common voltage is converted, the first gate line is turned on after a setup duration, and the source line transmits a display data to charge the first sub-pixel for a first write in duration;
when the first gate line is turned off for a wait duration, the second gate line is turned on and the source line transmits the display data to charge the second sub-pixel for a second write in duration; and
when the second gate line is turned off for the wait duration, the third gate line is turned on and the source line transmits the display data to charge the third sub-pixel for the second write in duration.

2. The method of claim 1, wherein the first write in duration is longer than the second write in duration.

3. The method of claim 1, wherein sum of the setup duration, the first write in duration, two times the second write in duration and three times the wait duration does not exceed a period between each time the common voltage converts polarity.

4. The method of claim 1, further comprising:
adjusting the first write in duration and the setup duration for the first write in duration to be longer than the second write in duration.

5. The method of claim 4, wherein when the first write in duration is increased by an adjustment duration, the setup duration is reduced by the adjustment duration.

6. The method of claim 4, wherein when the first write in duration is reduced by an adjustment duration, the setup duration is increased by the adjustment duration.

7. The method of claim 1, further comprising:
when the third gate line is turned off, the source line stops transmitting the display data after the wait duration.

8. The method of claim 7, further comprising:
after the source line stops transmitting the display data, the common voltage converts polarity.

9. The method of claim 1, wherein the first sub-pixel is a red sub-pixel, the second sub-pixel is a green sub-pixel and the third sub-pixel is a blue sub-pixel.

10. The method of claim 1, further comprising:
adjusting the first write in duration and the setup duration so when the display data reach a predetermined voltage level, the first sub-pixel is still in a charging state.
